(19) United States
(12) Patent Application Publication
(10) Pub. No.: US 2006/0093734 A1
(43) Pub. Date: May 4, 2006

(54) Method of applying phosphor paste of PDP

(75) Inventors: Masayuki Seto, Kawasaki (JP); Masahiro Sawa, Kawasaki (JP); Kouji Oohira, Kawasaki (JP); Naoto Yanagihara, Kawasaki (JP); Minahiro Nonomura, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Kawasaki (JP)

(21) Appl. No.: 11/258,001

(22) Filed: Oct. 26, 2005

(30) Foreign Application Priority Data
Nov. 1, 2004 (JP) 2004-318329

(51) Int. Cl. B05D 5/06; B05D 5/12

(52) U.S. Cl. 427/68

(57) ABSTRACT

A method of applying a phosphor paste of PDP includes the steps of disposing a screen mask on a substrate formed with a number of barrier ribs, applying a phosphor paste on the screen mask, and filling phosphor paste into cells by discharging the phosphor paste from apertures of the screen mask. The barrier ribs are formed on the substrate so that the each concave part becoming the cell forms independent space. The screen mask includes filling apertures and discharging apertures. Each of filling apertures is formed on a position corresponding to the concave part becoming the cell. Each of the discharging apertures is formed between the filling apertures so as to remove air outside, the air being accumulated within the cell when the phosphor paste is filled in the cell.

### CROSS-REFERENCE TO RELATED APPLICATION

This application is related to Japanese Patent Application No. 2004-318329 filed on Nov. 1, 2004, on the basis of which priority is claimed under 35 USC §119, the disclosure of this application being incorporated by reference in its entirety.

### BACKGROUND OF THE INVENTION

1. Field of the Invention

The present invention relates to a method of applying phosphor paste of a PDP (plasma display panel) and more particularly, relates to a method of applying phosphor paste of a PDP using a screen mask.

2. Description of the Related Art

A PDP generally forms on a substrate on the back surface side barrier ribs for partitioning discharge spaces for every cell and forms a phosphor layer in the cell partitioned by the barrier ribs. A mainstream method of forming phosphor layers, at present, is a screen printing method by which the phosphor layers are formed by filling phosphor paste in the cell, followed by firing.

By the way, there exist various kinds of barrier ribs, such as a belt-like one (generally so called as a “stripe-like rib”), grid-like one (generally so called as a “grid-like rib”).

In the case where the phosphor paste is filled in cells by a screen printing method, it is general that a screen mask with a straight pattern is used for stripe-like ribs and a screen mask with a dot pattern is used for grid-like ribs (refer to Japanese Unexamined Patent Application Publication No. 5-299019).

However, if a screen printing of grid-like ribs is performed using a screen mask with a dot pattern, spaces in cells are blocked by the screen mask, and release of air in the cells becomes difficult, thereby decreasing the amount of filling of the phosphor paste into the cells; and therefore, there arises a problem in that luminance of the cell becomes low when commercialization is achieved.

In order to solve the problem, use of a screen mask with a straight pattern with respect to the grid-like ribs is considered. However, in this case, although filling of phosphor paste is no problem, much phosphor paste attaches on the top part of a barrier rib. Therefore, a phosphor material after firing is also solidified and remained on the top part of the barrier rib; and when a substrate assembly on the front surface side faces a substrate assembly on the back surface side in assembling a panel, the phosphor material on the top part of the barrier rib comes in contact with the substrate assembly on the front surface side, resulting in flying in a discharge cell. This makes a discharge voltage increase and therefore, there arises a problem to generate an uneven display.

Therefore, a screen printing method capable of simultaneously satisfying “sufficient filling of the phosphor paste into cells” and “reduction of the amount of attachment of the phosphor paste onto the top part of the barrier ribs” has been desired to be provided.

### SUMMARY OF THE INVENTION

The present invention has been made in view of such circumstances, in a screen printing method which fills phosphor paste with respect to grid-like ribs. It is an object to provide a method capable of simultaneously satisfying sufficient filling of phosphor paste into cells and reduction of the amount of attachment of phosphor paste onto the top part of barrier ribs by considering shapes of the aperture in the screen mask.

The present invention provides a method of applying a phosphor paste of PDP, the method comprising: disposing a screen mask having specific shaped mesh-like apertures on a substrate formed with a number of barrier ribs; applying a phosphor paste on the screen mask; and filling the phosphor paste into concave parts, each of the concave parts becoming a cell, surrounded by the barrier ribs by discharging the phosphor paste from the apertures of the screen mask by pressing the phosphor paste with a scraper, wherein the barrier ribs are formed on the substrate so that the each concave part becoming the cell forms independent space, and the screen mask is composed of filling apertures and discharging apertures, each of the filling apertures being formed on a position corresponding to the concave part becoming the cell so that the phosphor paste is filled in the concave part becoming the cell, each of the discharging apertures being formed between the filling apertures so as to remove air outside, the air being accumulated within the concave part becoming the cell when the phosphor paste is filled in the concave part becoming the cell.

According to the present invention, when screen printing is performed, air accumulated within the concave part becoming a cell, is removed outside from the discharging aperture in the screen mask, thus the phosphor paste is sufficiently filled in the concave part becoming the cell. Further, the filling aperture in the screen mask is formed on a position corresponding to the concave part becoming the cell, which is an independent space. The phosphor paste is filled in the concave parts becoming the cell via the filling apertures, thus filling pressure is adjusted and the phosphor paste does not attach to a top part of the barrier rib, whereby sufficient filling of phosphor paste into the cell and reduction of the amount of attachment of phosphor paste onto the top part of barrier ribs are simultaneously satisfied.

### BRIEF DESCRIPTION OF THE DRAWINGS

FIG. 1 is a partially exploded perspective view showing a configuration of a PDP in an embodiment of the present invention;

FIG. 2 is an explanation view showing a panel assembly on the back surface side of the PDP in the embodiment;

FIG. 3 is an explanation view showing a state where the screen mask is disposed in the panel assembly on the back surface side of the PDP in the embodiment;

FIG. 4 is a partially enlarged view of a screen mask used in the embodiment;

FIGS. 5(a) to 5(d) are explanation views showing a method of a screen printing in the embodiment;

FIG. 6 is an explanation view showing a filling state of phosphor paste depending on movement of a squeegee in the embodiment;

FIG. 7 is an explanation view planarly showing the filling state of phosphor paste depending on movement of the squeegee in the embodiment;

FIGS. 8(a) and 8(b) are explanation views showing a state where air is removed from a slit aperture in the embodiment;

FIGS. 9(a) and 9(b) are explanation views showing a state where phosphor paste is filled in a concave part becoming a cell in the embodiment;

FIGS. 10(a) and 10(b) illustrate an comparison example showing a case where an aperture of the screen mask is provided with a straight pattern; and

FIGS. 11(a) to 11(c) illustrate a comparison example showing a case where an aperture of the screen mask is provided with a dot pattern.

### DESCRIPTION OF THE PREFERRED EMBODIMENTS

In the present invention, the substrate includes a substrate made of glass, quartz, ceramic or the like and a substrate in which a desired component such as an electrode, insulating film, dielectric layer and protective film is formed thereon.

The barrier ribs can be formed by a sandblast method, printing method, photo-etching method, or the like. For example, the barrier ribs are formed by the sandblast method, in which glass paste composed of low-melting point glass frit, binder resin, solvent, and the like is applied on the dielectric layer and dried, then cut particles are sprayed in a state where a cutting mask having an aperture of a barrier rib pattern on the glass paste layer is provided to cut the glass paste layer exposed at the aperture of the mask, followed by forming by further firing. Further, in the case of the photo-etching method, photosensitive resin is used as the binder resin in place of cutting with cutting particles; exposure and development are performed using the mask, followed by forming by firing. In the case of the printing method, the glass paste is subjected to multiple printing on the dielectric layer by a screen printing to form the glass paste layer which becomes barrier ribs with a desired height on a desired position, followed by forming by firing.

The barrier ribs may be formed on the substrate so that a concave part becoming a cell forms an independent space. For example, a grid-like barrier rib structure so called as a box-like rib or waffle-like rib may be provided; and a barrier rib structure which periodically forms a discharge part and a non-discharge part, so called as a meander rib or a fishbone-like rib may be provided.

In this case, the concave part becoming the cell may be substantially independent space. That is, even when a barrier rib structure has a space which communicates a concave part becoming a cell with a concave part becoming a cell, if the communicating space is not substantially operative as a cell, these concave parts can be deemed to be independent with each other. As described, the present invention includes such a barrier rib structure in which a space that is not substantially operative as a cell exists between a concave part becoming a cell and a concave part becoming a cell.

As for the screen mask, the screen mask known in the art used in the screen printing method may be applied. The screen mask may be configured such that the aperture is composed of filling apertures and discharging apertures. The filling aperture may be formed in a position corresponding to the concave part becoming the cell for filling phosphor paste in the concave part becoming the cell. The discharging aperture may be provided if it operates that air accumulated in the concave part becoming the cell is removed outside when the phosphor paste is filled in the concave part becoming the cell formed between the filling apertures.

Specifically, the discharging-aperture of the screen mask may be formed as a slit aperture having a constant width directly connecting the filling aperture and the filling aperture. The slit aperture is preferable to be formed as a slit having a constant width of 40 to 60 μm. The filling aperture is preferable to be formed as an aperture having a rectangular aperture of 420 to 560 μm×110 to 140 μm.

The phosphor paste is not specifically limited and any phosphor paste known in the art may be used. For example, phosphor powder, binder resin, one mixed and kneaded with solvent, and the like may be used. Viscosity of phosphor paste may be appropriately adjusted by regulating the binder resin, solvent, and the like in response to screen printing finish.

As for a scraper for pressing the phosphor paste applied on the screen mask, any one so called as a squeegee known in the art may be used.

The present invention will be described below in detail based on an embodiment shown in the drawings. In addition, the present invention is not limited to this description, but various modifications are capable of being used.

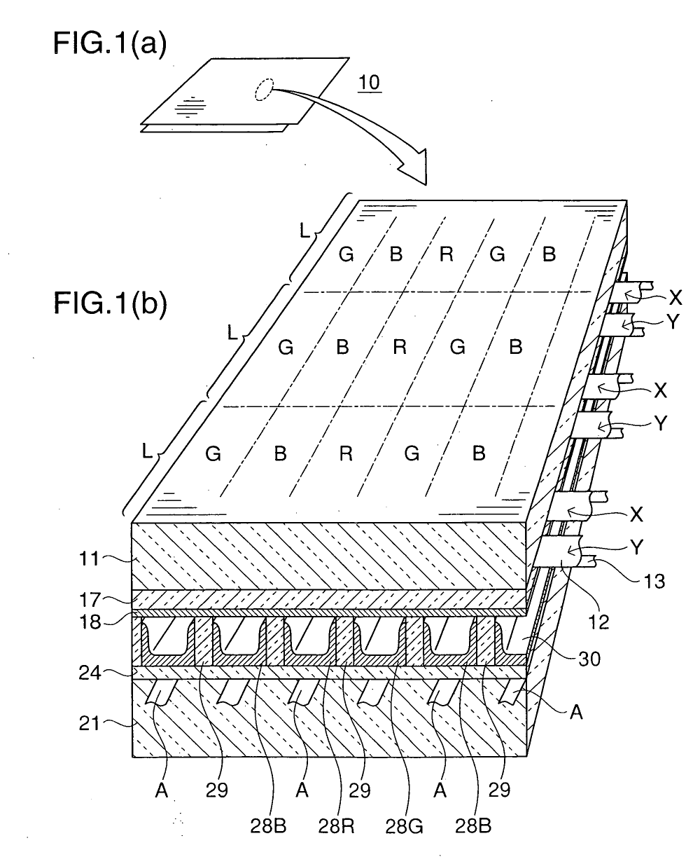

FIG. 1 is a partially exploded perspective view showing a configuration of a PDP in which a method of applying phosphor paste according to the present invention is applied. The PDP is an AC type PDP of a three electrode surface discharging type configuration for color displaying.

The PDP is composed of a panel assembly on the front surface side including a substrate 11 on the front surface side and a panel assembly on the back surface side including a substrate 21 on the back surface side. The substrate 11 on the front surface side and the substrate 21 on the back surface side are of a glass substrate; but, other than that, a quartz substrate, ceramic substrate, or the like may be used.

A pair of horizontal display electrodes X and Y are formed in the internal side of the substrate 1 1 on the front surface side via a non-discharging distance (a reverse slit). A display line L is defined between the display electrode X and the display electrode Y. Each of the display electrodes X and Y is composed of a transparent electrode 12 with a wide width, such as ITO, SnO₂, and a bus electrode 13 with a narrow width made of metal, for example, Ag, Au, Al, Cu, Cr and their laminated body (for instance, a laminated film of Cr/Cu/Cr). The display electrodes X and Y can be formed with a desired number, thickness, width and interval by using thick film formation technology such as screen printing for Ag and Au, and by using thin film formation technology such as an evaporation method and a sputtering method, or an etching technology for the remaining materials.

A dielectric layer 17 for driving alternating current (AC) is formed on the display electrodes X and Y so as to cover the display electrodes X and Y. The dielectric layer 17 is formed by applying low melting point glass paste on the substrate 11 on the front surface side by a screen printing method, followed by firing.

A protective film 18 for protecting the dielectric layer 17 from damage due to impinging of ion produced by discharge in displaying is formed on the dielectric layer 17. The protective film is made up of, for example, MgO, CaO, SrO, and BaO.

A plurality of address electrodes A are formed in the internal surface of the substrate 21 on the back surface side in a direction intersecting with the display electrodes X and Y taken from a planar view; and a dielectric layer 24 is formed covering the address electrodes A. The address electrode A is provided to produce address discharge for selecting an emission cell at a part intersecting with the electrode Y and is formed in a three layer type configuration composed of Cr/Cu/Cr. As for other materials, the address electrode A may be made up of, for example, Ag, Au, Al, Cu, and Cr. The address electrode A, similar to the display electrodes X and Y, can also be formed with a desired number, thickness, width and interval by using thick film formation technology such as screen printing for Ag and Au, and by using thin film formation technology such as an evaporation method, and a.sputtering method, or an etching technology for the remaining materials. The dielectric layer 24 can be formed using the same material and the same method as in the case of the dielectric layer 17.

A plurality of barrier ribs 29 are formed on the dielectric layer 24 between adjoining the address electrodes A and the address electrodes A. The barrier ribs 29 can be formed by a sandblast method, printing method, photo-etching method, or the like. For example, the barrier ribs are formed by the sandblast method, in which glass paste composed of low-melting point glass frit, binder resin, solvent, and the like is applied on the dielectric layer 24 and dried, then cut particles are sprayed in a state where a cutting mask having an aperture of a barrier rib pattern on the glass paste layer is provided to cut the glass paste layer exposed at the aperture of the mask, followed by forming by further firing. Further, in the case of the photo-etching method, photosensitive resin is used as the binder resin in place of cutting with cutting particles; exposure and development are performed using the mask, followed by forming by firing.

Phosphor layers 28R, 28G, and 28B of R (red), G (green) and B (blue) are formed on the side surface of the barrier ribs 29 and on the dielectric layer 24 between the barrier ribs. The phosphor layers 28R, 28G, and 28B are formed by applying phosphor paste, which includes phosphor powder, binder resin, and solvent, in a concave groove-like discharge space between the barrier ribs 29 by a screen printing method or a method using a dispenser; repeating this processing for every color; followed by firing. The phosphor layers 28R, 28G, and 28B can also be formed by photolithography technology using a sheet-like phosphor layer material (so called as green sheet) which includes phosphor powder, photosensitive material, and binder resin. In this case, a desired color sheet is stuck on the entire surface of display area on the substrate to perform exposure and development, and this processing is repeated for every color, thereby forming each color phosphor layer between the corresponding barrier ribs.

The PDP is made by disposing the panel assembly on the front surface side opposite to the panel assembly on the back surface side so that the display electrodes X and Y intersect with the address electrodes A, by sealing the circumference, and by filling discharge gas in the discharge space 30 surrounded by the barrier ribs 29. In this PDP, the discharge space 30 at the intersection between the display electrodes X and Y and the address electrode A is defined as a cell region (unit emitting region), a minimum unit for display. One pixel is composed of three cells of R, G, and B.

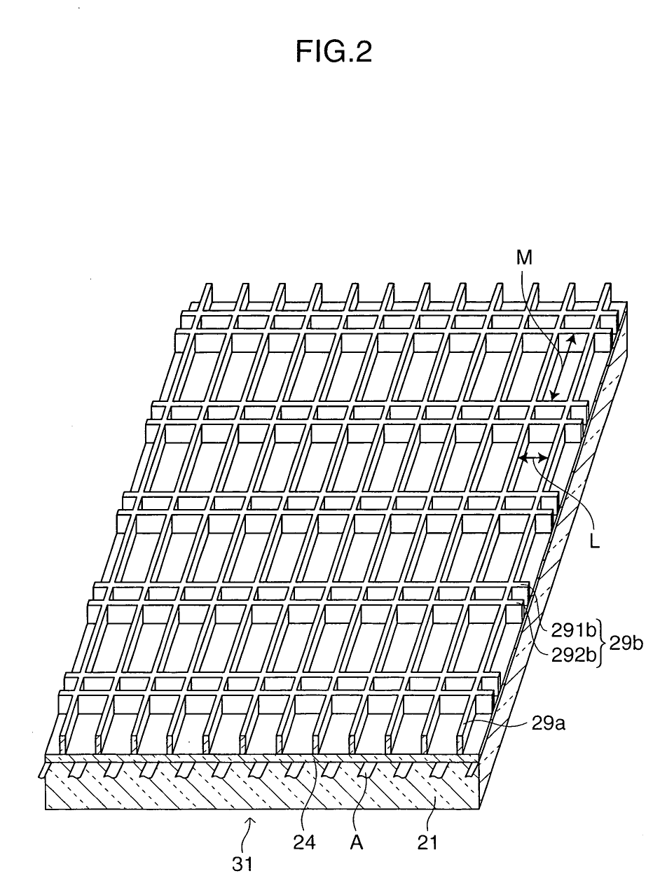

FIG. 2 is an explanation view showing a panel assembly on the back surface side.

A panel assembly 31 on the back surface side is configured such that the address electrodes A, the dielectric layer 24, and the grid-like barrier ribs 29 are formed on the substrate 21 on the back surface side.

The grid-like barrier ribs 29 are composed of main barrier ribs 29a vertically linearly formed in the screen and auxiliary barrier ribs 29b horizontally linearly formed in the screen. Each of the auxiliary barrier ribs 29b is further composed of a pair of a first auxiliary barrier rib 291b and a second auxiliary barrier rib 292b. A cavity is formed between the first auxiliary barrier rib 291b and the second auxiliary barrier rib 292b.

A length (length marked by L shown in the drawing: inner dimension between the barrier ribs) between the main barrier rib 29a and the main barrier rib 29a is approximately 240 μm. This dimension may be 00 to 250 μm. A length (length marked by M shown in the drawing: inner dimension between the barrier ribs) between the auxiliary barrier rib 29b and the auxiliary barrier rib 29b is approximately 640 μm. This dimension may be 630 to 650 μm.

The cell is formed in a concave part surrounded by the main barrier ribs 29a and the auxiliary barrier ribs 29b. Therefore, planarly dimension of the discharge space of the cell is approximately 240 μm in horizontal length and 640 μm in vertical length.

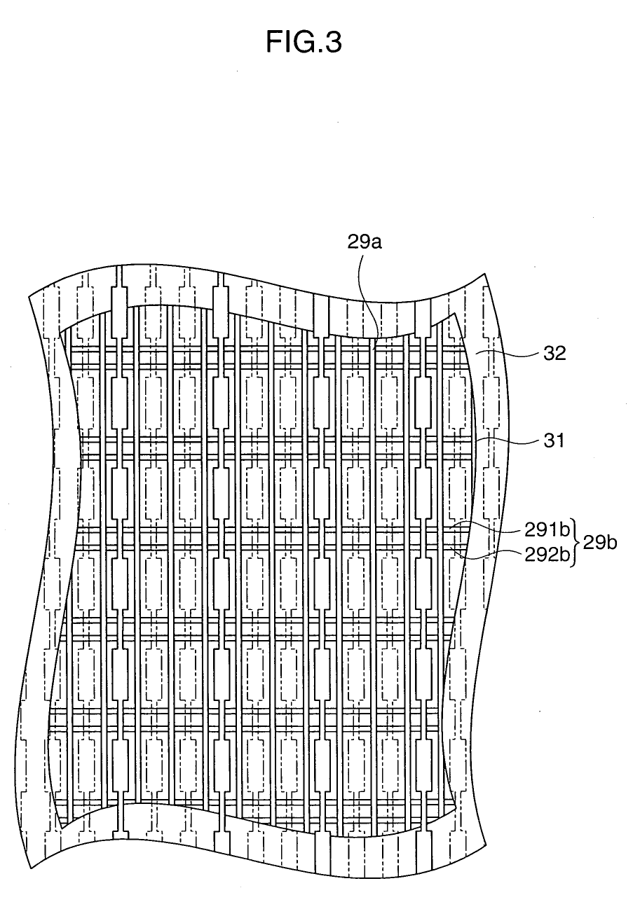

FIG. 3 is an explanation view showing a state where the screen mask is disposed in the panel assembly on the back surface side.

The phosphor paste is filled in the aforementioned cell. This filling is performed using the screen printing method. In the screen printing method, as shown in the drawing, a screen mask 32 is disposed by positioning to the panel assembly 31 on the back surface side. Then, as to be described later, the phosphor paste is applied on the screen mask 32 and is stenciled by a squeegee (a scraper-like pressing tool), thereby filling the phosphor paste in the concave part becoming the cell via an aperture of the screen mask 32.

This screen printing is performed three times using the phosphor paste of three colors R (red), G (green) and B (blue). That is, printing for every color is performed using a screen mask in which apertures are provided at portions corresponding to R color cells to print phosphor paste for R (red), a screen mask in which apertures are provided at portions corresponding to G color cells to print phosphor paste for G (green), and a screen mask in which apertures are provided at portions corresponding to B color cells to print phosphor paste for B (blue).

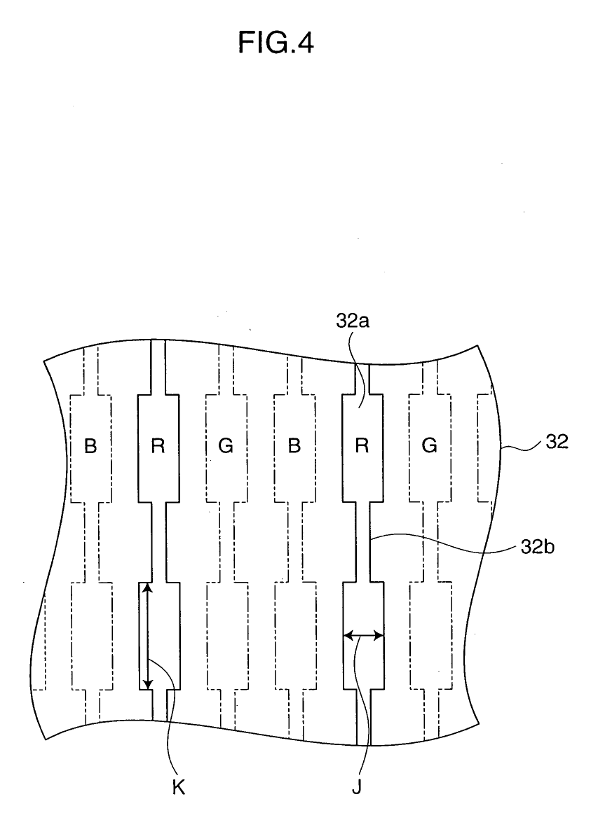

FIG. 4 is a partially enlarged view of a screen mask.

Mesh-like apertures are provided in the screen mask. The aperture is a bunching pattern in which dot-like pattern is connected in a straight line. That is, the aperture is composed of a filling aperture 32a formed at a position corresponding to the cell to fill the phosphor paste in the cavity of the cell and a slit aperture 32b having a constant width linearly connecting the filling aperture 32a to the filling aperture 32a. The slit aperture 32b is provided for removing air accumulated in the concave part outside when the phosphor paste is filled in the concave part becoming the cell.

A length (length marked by J in the drawing) in the width direction of the filling aperture 32a is approximately 120 μm. The dimension may be 100 to 140 μm. A length (length marked by K in the drawing) in the longitudinal direction of the filling aperture 32a is approximately 420 μm. The dimension may be 420 to 560 μm. A width of the slit aperture 32b is approximately 50 μm. The width may be 40 to 60 μm.

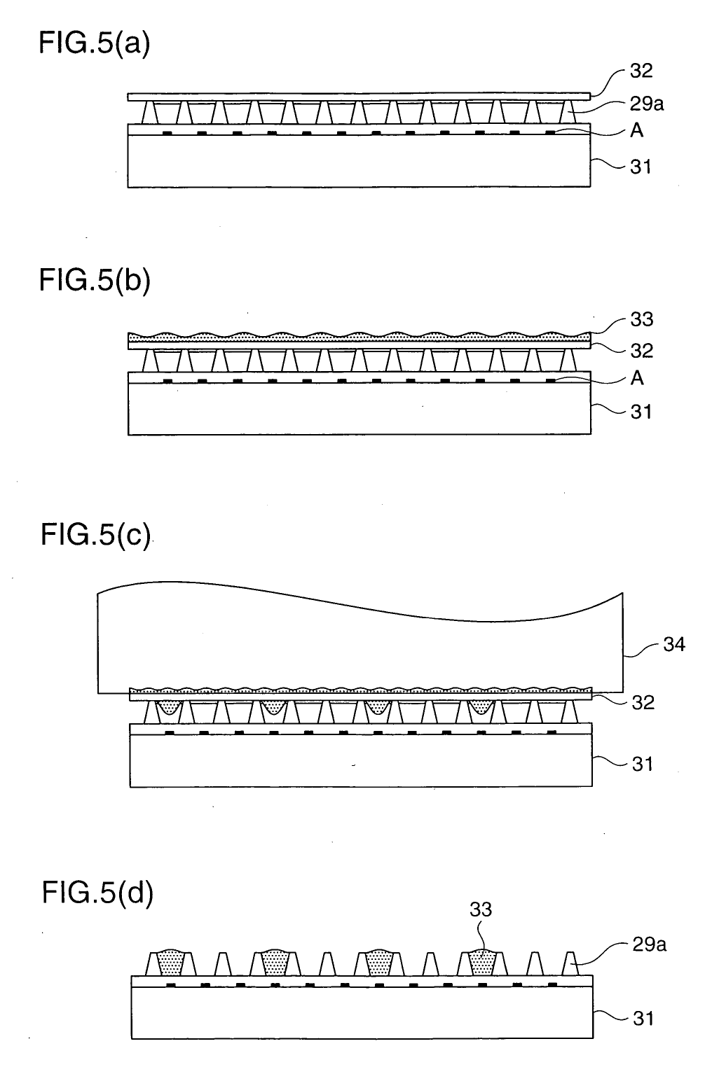

FIGS. 5(a) to 5(d) are explanation views showing a screen printing method. These figures show states where the panel assembly on the back surface side is seen from a direction perpendicular to the main barrier ribs 29a.

In the screen printing, the screen mask 32 is disposed by positioning to the panel assembly 31 on the back surface side (refer to FIG. 5(a)). Next, phosphor paste 33 is applied on the screen mask 32 (refer to FIG. 5(b)). This application is manually performed with a brush. The phosphor paste uses three colors R (red), G (green) and B (blue), but any one known in the art, in which phosphor powder and organic binder resin are added to solvent, is used for all these colors.

Next, a squeegee 34 is made to move along the main barrier ribs 29a to stencil the phosphor paste 33 with the squeegee 34 (refer to FIG. 5(c)). This movement of the squeegee 34 is manually performed, thereby filling the phosphor paste in the concave part becoming the cell via the aperture of the screen mask 32.

The screen mask 32 is peeled off in order from the panel assembly on the back surface side with the movement of the squeegee 34.

When the squeegee 34 is moved to the end of the main barrier ribs 29a, the screen mask 32 is automatically peeled off from the panel assembly on the back surface side, whereby the phosphor paste is filled in the concave part becoming the cell (refer to FIG. 5(d)). This screen printing is performed for every phosphor paste R, G, and B.

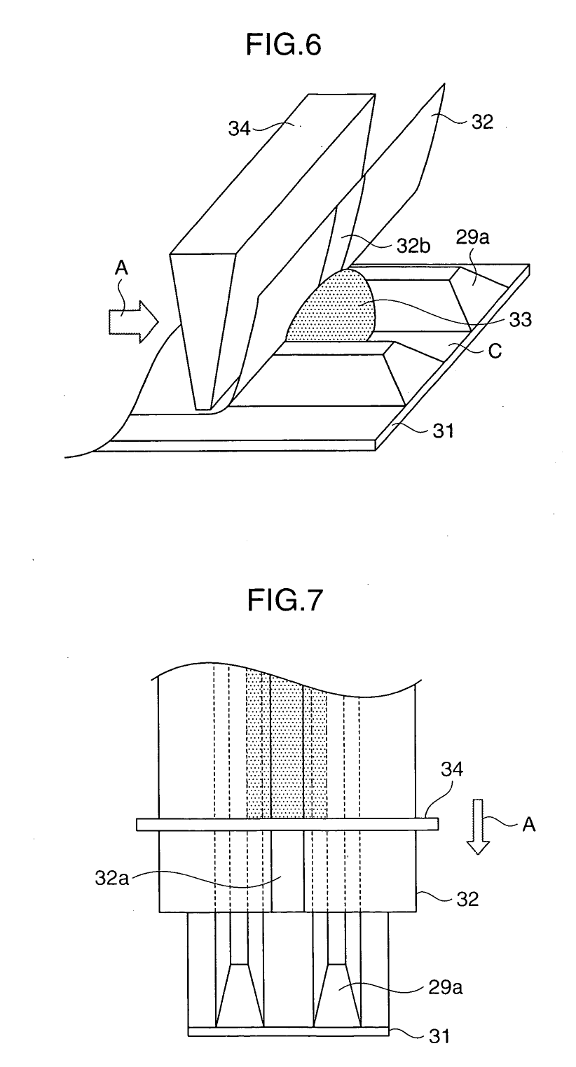

FIG. 6 is an explanation view showing a filling state of the phosphor paste depending on the movement of the squeegee. The squeegee 34 is moved along the main barrier ribs 29a in a direction marked by the arrow A shown in the drawing. When the phosphor paste 33 is filled in the concave part of the cell C, air accumulated in the concave part of the cell C is removed outside from the exhausting slit aperture 32b, and the phosphor paste 33 is sufficiently filled in the concave part of the cell C.

FIG. 7 is an explanation view planarly showing a filling state of the phosphor paste depending on the movement of the squeegee. A hatched portion shown in the drawing is a portion where the phosphor paste was filled.

Since the aperture of the screen mask is composed of the filling aperture 32a and the slit aperture 32b, the phosphor paste 33 is sufficiently filled in the concave part of the cell C, but the phosphor paste 33 is not attached to the top part of the main barrier rib 29a.

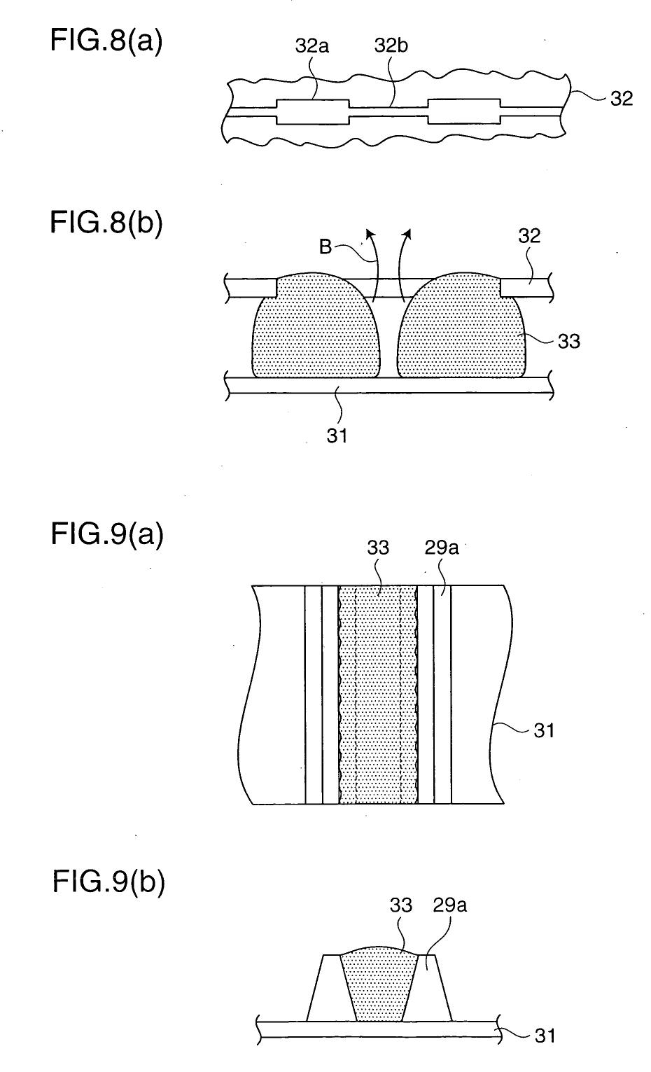

FIG. 8(a) is an explanation view planarly showing the aperture of the screen mask; FIG. 8(b) is an explanation view showing a state where air is removed from the slit aperture, and the state seen from a direction parallel to the main barrier ribs 29a is shown.

The filling aperture 32a and the slit aperture 32b are formed in the screen mask 32 as shown in the drawing. Therefore, when the phosphor paste is filled from the filling aperture 32a, air in the concave part becoming the cell is removed outside the screen mask 32 from the slit aperture 32b as shown by the arrow marked B in the drawing. Since an air release passage into the printing direction is secured by the slit aperture 32b, the amount of filling of the phosphor paste becomes sufficient, whereby surface shape of the phosphor paste after printing becomes stable.

FIGS. 9(a) and 9(b) are explanation views showing a state where the phosphor paste is filled in the concave part becoming the cell. FIG. 9(a) is a state planarly showing the panel assembly on the back surface side; and FIG. 9(b) is a state where the panel assembly on the back surface side is seen from a direction perpendicular to the main barrier ribs 29a.

As shown in these drawings, when the phosphor paste 33 is filled in the concave part becoming the cell using the screen mask 32 shown in FIG. 4, the phosphor paste 33 is sufficiently filled in the concave part becoming the cell, whereby surface shape of the phosphor body after printing becomes stable. Further, the phosphor paste 33 does not attach to the top part of the main barrier rib 29a.

As described above, attachment of the phosphor paste to the barrier rib top part is reduced, thereby preventing the phosphor material from flying in the discharge cell in panel assembling, whereby an uneven display due to a change in discharge voltage after panel assembling can be suppressed.

In addition, in the case where the bunching pattern is used in the grid-like ribs, the phosphor paste is partially attached to lateral ribs. But, the amount of attachment of this sort does not produce problem such as the aforementioned change in discharge voltage or the like.

The PDP includes cell shapes such as the stripe-like rib, grid-like rib, or the like; and the optimal shape other than the bunching can be considered for such cell shapes provided that the pattern design is focused on adjustment of filling pressure and the air release in printing.

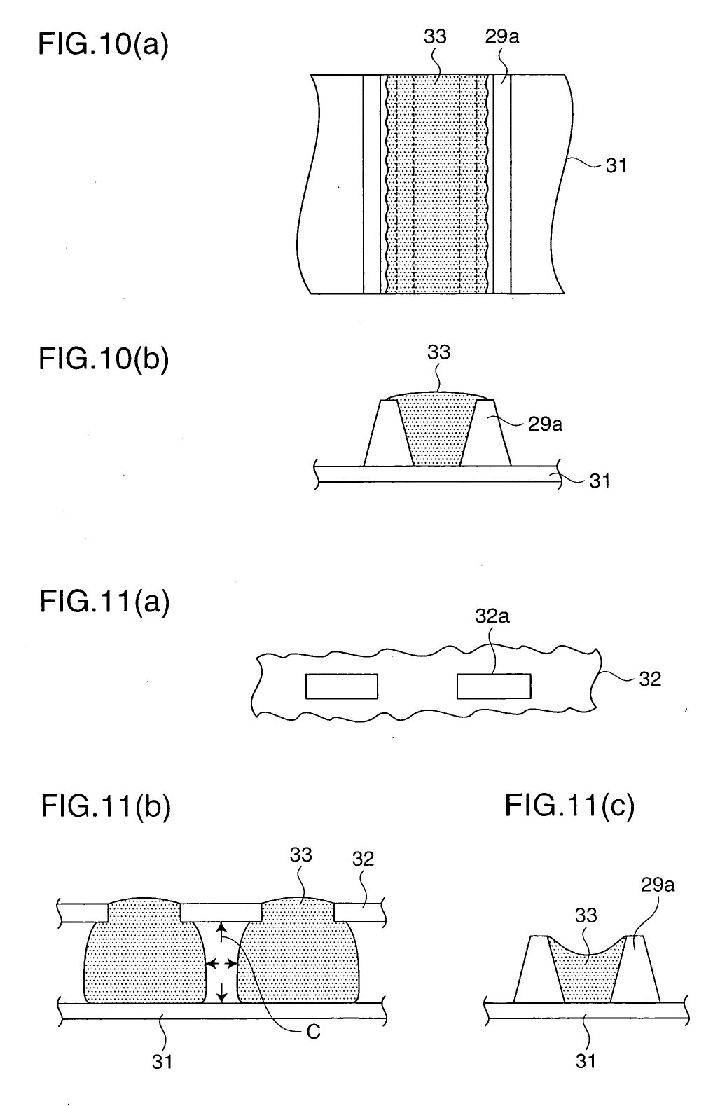

FIGS. 10(a) and 10(b), and FIGS. 11(a) and 11(b) illustrate comparison examples.

Each of FIGS. 10(a) and 10(b) shows a case where the aperture of the screen mask is a continuously straight pattern. FIG. 10(a) and FIG. 10(b) correspond to FIG. 9(a) and FIG. 9(b), respectively.

As shown in the drawing, in the case where the aperture of the screen mask 32 is a straight pattern, when the screen printing is performed, the phosphor paste is attached on the top part of the main barrier rib 29a when the phosphor paste is filled in the concave part becoming the cell via an aperture of the mask. This occurs because the filling pressure of the phosphor paste is needlessly large.

Each of FIGS. 11(a) to 11(c) shows a case where the aperture of the screen mask is only the filling aperture (dot pattern). FIG. 11(a) and FIG. 11(b) correspond to FIG. 8(a) and FIG. 8(b), respectively. FIG. 11(c) shows a state where the phosphor paste is filled in the concave part becoming the cell.

As described above, in the case where the aperture of the screen mask 32 is the straight pattern, the phosphor paste is attached to the top part of the main barrier rib 29a. It is therefore considerable that, in order to solve this problem, the dot pattern is provided only for the filling aperture 32a as the aperture in the screen mask 32 and the filling pressure of the phosphor paste is adjusted, thereby preventing the phosphor paste from attaching on the top part of the main barrier rib 29a.

However, in the case where the aperture of the screen mask 32 is the dot pattern made up of only the filling aperture 32a, when the screen printing is performed and the phosphor paste is filled in the concave part becoming the cell from the filling aperture 32a, air accumulated in the concave part becoming the cell is not removed outside the screen mask 32 from any direction as shown by the arrow C in the drawing, and therefore, filling of the phosphor paste in the concave which becomes the cell is difficult. Consequently, the phosphor paste is not sufficiently filled in the concave part becoming the cell.

As described above, when the amount of filling of the phosphor paste during the screen printing is given out, the surface of the phosphor paste after filling caves in. When this is dried and fired, the thickness of the phosphor layer becomes thin and causes the luminance to decrease.

What is claimed is:

1. A method of applying a phosphor paste of PDP, the method comprising:
disposing a screen mask having specific shaped mesh-like apertures on a substrate formed with a number of barrier ribs;
applying a phosphor paste on the screen mask; and
filling the phosphor paste into concave parts, each of the concave parts becoming a cell, surrounded by the barrier ribs by discharging the phosphor paste from the apertures of the screen mask by pressing the phosphor paste with a scraper,
wherein the barrier ribs are formed on the substrate so that the each concave part becoming the cell forms independent space, and
the screen mask is composed of filling apertures and discharging apertures, each of the filling apertures being formed on a position corresponding to the concave part becoming the cell so that the phosphor paste is filled in the concave part becoming the cell, each of the discharging apertures being formed between the filling apertures so as to remove air outside, the air being accumulated within the concave part becoming the cell when the phosphor paste is filled in the concave part becoming the cell.

2. The method of claim 1, wherein each of the discharging apertures of the screen mask is formed as a slit aperture having a constant width directly connecting the filling aperture and the filling aperture.

3. The method of claim 2, wherein each of the slit apertures of the screen mask is formed as a slit with a constant width of 40 to 60 μm.

4. The method of claim 2, wherein each of the filling apertures of the screen mask is formed as a rectangular aperture with a dimension of 420 to 560 μm×100 to 140 μm.
